(19) United States
(12) Patent Application Publication
(10) Pub. No.: US 2015/0242181 A1
(43) Pub. Date: Aug. 27, 2015

(54) Rhythm Adaptation Method for Audio Playback

(71) Applicant: Irina Georgievna Smirnoff, Wadsworth, OH (US)

(72) Inventor: Irina Georgievna Smirnoff, Wadsworth, OH (US)

(73) Assignee: Irina Smirnoff, Wadsworth, OH (US)

(21) Appl. No.: 14/187,301

(22) Filed: Feb. 23, 2014

(51) Int. Cl. G06F 3/16; G05B 15/02

(52) U.S. Cl. CPC G06F 3/165; G05B 15/02

(57) ABSTRACT

The rhythm adaptation method provides an automatic adjustment of the rhythm and tempo of music played by electronic playback devices to the beats and frequencies of external acoustical or visual signals. The adaptation is done through detection of discernible frequencies, beats, or vibrations from ambient acoustical and/or visual signals with a subsequent adjustment of the musical tempo so as to bring it to a correspondence with the ambient signals.

### CROSS REFERENCE TO RELATED APPLICATIONS

(1) 61/883,981 Provisional: “Beat Frequency Adaptation Method for Audio Playback”

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

This invention relates to the field of automated adaptation of rhythms of music played back on electronic devices to audible ambient beats coming from the surrounding environment.

(2) Description of Related Art including information disclosed under 37 CFR 1.97 and 1.98.

1. U.S. Pat. No. 8,606,573. Konchitsky, et al., Dec. 10, 2013

### BRIEF SUMMARY OF THE INVENTION

This invention proposes a method to program a music player device, such as an mp3 player, car audio system, smartphone, and the like, so as to to automatically adjust the rhythm of music played by the device to the detectable audio beats and/or visual signals coming from the abmient environment.

### BRIEF DESCRIPTION OF THE SEVERAL VIEWS OF THE DRAWING

Not Applicable

### DETAILED DESCRIPTION OF THE INVENTION

This patent application describes a method to adjust rhythms of music played by a music player device to the rhythms of the ambient acoustical sources, light sources, or visible motion. The sources of such rhythms may come from the environment, from other devices, or from animate or inanimate objects operating in the vicinity of the playback device. As a result of such adjustment the perception of the ambient signel can be changed from a negative to a positive.

Following the algorithm based on this method, a playback device will detect (sense) external signals, process them to extract the fundamental frequencies, and adjust the rhythms of the played music to match these frequencies or their overtones (harmonics). Some examples of external signals can include but not limited to: vibrations, windshield wipers, noise from the different objects around listener, noise from appliances, engine nose, nose from the tiers, blinking lights, rain, swishing of trees, as well as sounds produced by people or animals.

The rhythmic adjustment can be done for any acoustic signal generated by the device, including but not limited to: songs chosen from a radio, internal play-list, internet sources, a CD, and so on.

Other potential features of the device can include but be not limited to:

1. If the application is used in the car, the device can be programmed to measure the intensity of the external sounds and based on this adjust the volume.

2. The application can also implement the method of destructive interference to cancel the sound waves of a disturbing sounds. This method is used in the Boss Noise-canceling Headphones.

3. An option to lower the volume if the outside acoustic signal is produced by a conversation (duck effect).

4. Muting the music detecting specific sounds, including but not limited to:
(a) Ringing of the phone.
(b) Ringing of the skype or other PC or tablet application.
(c) Alarm sound.
(d) Appliances set or any other devices, which listener may pre program ahead of time.

5. Application/method can be programmed to react in a certain way on other special sounds. For example, the hand clap could be set as a signal to skip to the next song in a playlist, etc.

6. The application will work with internal or external speakers. If the speakers are external and spread apart from each other the volume will automatically go down (duck) within the space where the conversation has started. For example if a conversation started on the back seats of a car the volume of the speakers on the back of the car will be lowered.

7. The application software will adjust the generated sounds to the speech in oral presentations. Examples include, but not limited to:
(a) Detecting the rhythm of the speech and provide the background music with the same beat.
(b) Presentation of the product which makes a rhythmical noise.
(c) Presentation in a rhythmically noisy environment.

1. A method for playing back audio and comprising:
(a) providing an audio playback device equipped with an audio receiver capable of receiving and processing external audio signals during the playback,
(b) detecting frequencies of rhythmical beats from external audio signals received by said audio playback device during playback,
(c) instructing said playback device to control the playback depending on the value of the detected beat frequency.

2. The method of claim 1 wherein said playback device is instructed to set the speed of the played music depending on the detected beat frequency.

3. The method of claim 1 wherein said playback device is instructed to select the audio for the playback depending on the detected beat frequency.

4. A method for playing back audio and comprising:
(a) providing an audio playback device equipped with a video camera capable of receiving and processing external video signals during the playback,
(b) detecting frequencies of rhythmical beats from external video signals received by said audio playback device during playback,
(c) instructing said playback device to control the playback depending on the value of the detected beat frequency.

5. The method of claim 4 wherein said playback device is instructed to set the speed of the played music depending on the detected beat frequency.

6. The method of claim 4 wherein said playback device is instructed to select the audio for the playback depending on the detected beat frequency.
